(19) United States
(12) Patent Application Publication
(10) Pub. No.: US 2007/0257775 A1
(43) Pub. Date: Nov. 8, 2007

(54) Identification system and identification method

(76) Inventor: Tatsuji Nishijima, Atsugi (JP)

Correspondence Address: ERIC ROBINSON, PMB 955, 21010 SOUTHBANK ST., POTOMAC FALLS, VA, 20165, US

(21) Appl. No.: 11/790,077

(22) Filed: Apr. 23, 2007

(30) Foreign Application Priority Data
Apr. 28, 2006 (JP) 2006-124748

(51) Int. Cl. H04Q 5/22

(52) U.S. Cl. 340/10.1; 340/572.1; 340/10.2

(57) ABSTRACT

A method in which an interrogator identifies a wireless tag under a management of a management server provided with steps; the interrogator performs registration application to the management server, the management server performs registration of the interrogator, the management server makes interrogator information, the management server controls start and end of carrier sense performed by the interrogator, the management server controls transmission and stop of a wireless signal performed by the interrogator, the management server makes the interrogator transmit the result of carrier sense, the interrogator transmits the result of carrier sense, and the management server makes interrogator interference information.

### BACKGROUND OF THE INVENTION

1. Field of the Invention

The present invention relates to a system using an interrogator (also referred to as a reader/writer) conducting detection of a wireless tag and transmission and reception of information to and from a wireless tag. In particular, the present invention relates to a system in which a plurality of interrogators operate normally even when they are adjacent to one another.

2. Description of the Related Art

In recent years, with the diffusion of the Internet, IT (Information Technology) has been spread to all over the world, and a revolutionary change has been brought about. In particular, it is called ubiquitous information society that an environment in which anyone at anytime can access the network has been put into place. In such an environment, by giving each object an ID (individual identification number), history of the object becomes clarified, and this identification technology which may be made use of for manufacturing management and the like has attracted attention.

In general, as a technology to identify an item and the like, there is bar-code. Bar-code has played an important role in an identification system in realizing improvement in efficiency of operation such as inspection and sophistication of management by data. However, demand for identification system has been increasing and sophisticated more and more, and there have been cases in which bar-code is not sufficient in terms of function. On the other hand, a wireless tag (also referred to as ID tag, IC tag, IC chip, RFID (radio frequency identification) tag, wireless chip, electronic tag) which is capable of fulfilling those demands has attracted attention in recent years.

Each wireless tag is provided with a different identification number (UID: unique identifier) and a wireless communication apparatus to transmit the information to outside in accordance with a demand. In addition, as a device to read and write the content of memory included in the wireless tag, a wireless device called an interrogator (or a reader/writer) is used. The interrogator transmits command to the wireless tag and receives necessary response data from the wireless tag by conducting wireless communication using a carrier wave of a certain frequency. This carrier also serves to supply power to a passive type wireless tag which does not have a power source inside.

In a case of inspection using bar-code, since it is necessary that the information of bar-code is optically scanned by a bar-code scanner, reading operation must be done one by one at a close distance without an obstacle. While on the other hand, in a case of the wireless tag, with the use of an interrogator, information of a plurality of wireless tags can be read simultaneously from a distant place, and moreover, reading can be performed even if there is some obstacle between the wireless tag and the interrogator.

Thus, the identification system using the wireless tag and the interrogator can reduce the cost such as expense and time significantly and realize highly reliable data management when taking an inventory of a number of items. In addition, since the wireless tag can include a readable and writable memory, security function, and the like, realization of a novel advanced identification system such as a highly reliable traceability system is expected. As set forth above, the identification system using the wireless tag and the interrogator has attracted large attention; however, as one of the big problems of this identification system, when a plurality of interrogators are placed adjacent to one another, the plurality of wireless signals from the interrogators might cause interference. In other words, when a plurality of interrogators using the carrier wave with the same band of frequency are adjacently placed and the plurality of interrogators transmit wireless signal approximately simultaneously, wireless signals interfere depending on the positional relation of the plurality of interrogators. As a result, there is a problem that a wireless tag that has received a wireless signal to which interference has been caused can not decode the wireless signal transmitted from the interrogator correctly and can not execute the command from the interrogator normally.

In addition, some of the wireless tags detect the condition of a carrier from the interrogator and interpret the status as a command. For example, there is a wireless tag which has a function to reset its status when a wireless signal from an interrogator is not detected. In a case where a wireless tag having such a function is used, malfunction is also caused when carriers from a plurality of interrogators interfere. This is because when such a wireless tag is in a region where the carriers interfere, even if one interrogator stops transmitting a carrier in order to reset the status of the wireless tag, the wireless tag might receive a carrier from another interrogator, and so there is a case where the wireless tag can not detect that one interrogator has stopped transmitting a carrier.

As a measure to avoid such a problem, operation tends to be performed in such a way that an interrogator that is used in an identification system is actually placed in an operation site and circuit adjustment of the interrogator such as intensity of a carrier, sensitivity of signal detection, and the like is performed, and a wireless tag is moved experimentally to confirm the system operates as desired, and until problems such as interference of wireless signals from the interrogator are eliminated, circuit adjustment and testing are repeated. However, such operation often takes long time and there is a problem that the start of the actual operation is delayed. In addition, there are problems that such operation depends heavily on the environment in which the identification system operates and the technique of an operator, and there is malfunction due to accuracy decrease caused by the change in the environment after the start of operation.

Thus, in order to prevent the interference of carriers from the interrogators and to facilitate the setting operation easier, by adjustment of the timing of transmission of wireless signal by the interrogator interference of wireless signals may be prevented, and various methods to prevent the wireless signals from interfering have been provided.

For example, in order to prevent the wireless signal from interfering, one method is proposed which is to monitor the identification signal transmitted by other interrogators, and when an identification signal is recognized, wireless communication is not performed for a certain period of time, and to judge at all times if the interval of sequential wireless communications is proper at all times to avoid the interference of the wireless signal (for example, patent document 1). In addition, an interrogator transmits a sleep signal to the adjacent interrogators right before conducting a wireless communication with a wireless tag, and interrogators that have received the sleep signal do not operate as interrogators until they receive sleep cancellation signal (for example, patent document 2).

[Patent Document 1] Japanese Published Patent Application No. H11-102419

[Patent Document 2] Japanese Published Patent Application No. 2003-150916

### SUMMARY OF THE INVENTION

However, by the method disclosed in patent document 1, when a communication system is executed other than a polling method which transmits a signal at a constant interval, the interval of the wireless communication is not constant. Therefore when the number of interrogators whose wireless signals interfere is increased, it becomes difficult to secure the properness of the interval of sequential wireless communications. In addition, since sufficient interval is taken between each wireless communication with the other interrogators conducting wireless communication in mind, even when there is no interference with other interrogators, communication speed slows down inevitably. In addition, by the method mentioned in patent document 2, in a case where there are too many interrogators whose wireless signals may interfere, and a condition in which entropy (average information content) of the wireless communication is close to the upper limit continues, there can be malfunctions: there is an interrogator which misses the timing to transmit the sleep signal and can not conduct communication with the wireless tag for a long period, and a collision is caused since a plurality of interrogators wait for the sleep cancellation to transmit the sleep signal and the interrogators conduct wireless communication at the same time.

As thus, with a means to adjust the timing for wireless communication among interrogators, when in an environment where many interrogators exist, it is difficult for the interrogator to efficiently conduct wireless communication with the wireless tag while preventing the interference of signals.

Thus, an object of the present invention is to provide an identification system and an identification method in which even when a plurality of interrogators are adjacent to one other, the interrogators can efficiently conduct wireless communication with a wireless tag while avoiding the interference of wireless signals.

The identification system of the present invention includes an interrogator which conducts wireless communication with a wireless tag and a management server which manages the interrogator. The interrogator includes: a means for applying for registration to the management server, a means for performing carrier sense, a means for transmitting the result of carrier sense to the management server, a means for applying to the management server for a right to conduct wireless communication, a means for starting wireless communication by obtaining the right to conduct wireless communication, a means for returning the management server the right to conduct wireless communication when wireless communication is completed, and a means for applying to the management server for cancellation of registration. In addition, the management server includes: a means for registering the interrogator, a means for generating interrogator information, a means for making the interrogator transmit and stop the signal, a means for making the interrogator start and stop carrier sense, a means for making the interrogator transmit the result of carrier sense, a means for making an interrogator interference information, a means for imparting to the interrogator a right to conduct wireless communication, a means for suspending the imparting of the right to conduct wireless communication to the interrogator, a means for making suspend information, and a means for performing cancellation of registration of the interrogator. The management server includes a recording medium that can be read by a computer in which a program for the management server to function as these meanss is recorded.

The identification method of the present invention includes a method in which an interrogator under the management of a management server identifies a wireless tag, which includes the steps: the interrogator applies for registration to the management server, the management server registers the interrogator, the management server make interrogator information, the management server controls start and end of carrier sense by the interrogator, the management server controls transmission and stop of wireless signal by the interrogator, the management server makes the interrogator transmit the result of carrier sense to the management server, the interrogator transmits the result of carrier sense to the management server, and the management server makes interrogator interference information.

In addition, the identification method of the present invention is a method in which an interrogator identifies a wireless tag under the management of a management server, which includes: the interrogator applies to the management server for a right to conduct wireless communication, the management server suspends the imparting of the right to conduct wireless communication to the interrogator, the management server generates a suspend information, the management server imparts the right to conduct wireless communication to the interrogator, the interrogator to which the right to conduct wireless communication is imparted conducts wireless communication with a wireless tag, the interrogator returns the right to conduct wireless communication to the management server after the wireless communication with the wireless tag is ended, the interrogator applies to the management server for cancellation of registration, and the management server deregisters the interrogator.

In addition, the identification method of the present invention is a method in which an interrogator identifies a wireless tag under the management of a management server including, the interrogator applies to the management server for a right to conduct wireless communication, the management server imparts the right to conduct wireless communication to the interrogator, the interrogator to which the right to conduct wireless communication is imparted conducts wireless communication with a wireless tag, the interrogator returns the right to conduct wireless communication to the management server after the wireless communication with the wireless tag is ended, the interrogator applies to the management server for cancellation of registration, and the management server deregisters the interrogator.

In the identification method provided by the present invention, since equal to or more than two interrogators whose signals might interfere do not transmit wireless signals simultaneously, the interrogators can conduct wireless communication with a wireless tag while avoiding the interference between wireless signals of the interrogators. In addition, it is easy to place the interrogator, because a means for registering the interrogator and a means for canceling registration are provided.

In the identification method provided by the present invention, equal to or more than two interrogators whose signals might interfere do not transmit wireless signals simultaneously; the interrogators can conduct wireless communication with a wireless tag while avoiding the interference among wireless signals of the interrogators. In addition, in the identification method provided by the present invention, since a step of registering the interrogator on the management server and a step of canceling registration are provided, it is easy to set the interrogators.

### BRIEF DESCRIPTION OF DRAWINGS

FIG. 1 is a diagram showing the structure of an identification system in an embodiment mode of the invention.

FIG. 2 is a functional block diagram of an interrogator.

FIG. 3 is a diagram illustrating the concept of a memory portion of a management server.

FIG. 4 is a diagram showing the content of interrogator interference information.

FIG. 5 is a diagram showing the content of interrogator interference information.

FIG. 6 is a flow chart illustrating a procedure in which the management server generates the interrogator interference information.

FIG. 7 is a sequence diagram when the management server makes the interrogator interference information.

FIG. 8 is a flow chart illustrating procedure in which the interrogator conducts wireless communication with a wireless tag.

FIG. 9 is a flow chart illustrating a right application reception processing.

FIG. 10 is a flow chart illustrating a right return reception processing.

FIG. 11 is a sequence diagram when the interrogator conducts wireless communication with the wireless tag.

FIG. 12 is a diagram showing one example of the structure of the wireless tag.

### DETAILED DESCRIPTION OF THE INVENTION

Described below are embodiment modes of the present invention. However, the present invention is not limited to the following description, and it is easily understood by a person skilled in the art that without departing from the purpose and the scope of the present invention, modes and details can be changed variously. Therefore, the present invention should not be interpreted as being limited to the description of the embodiment modes given below.

### Embodiment Mode 1

In embodiment mode 1, described is one example of the structure of the identification system of the present invention with reference to drawings.

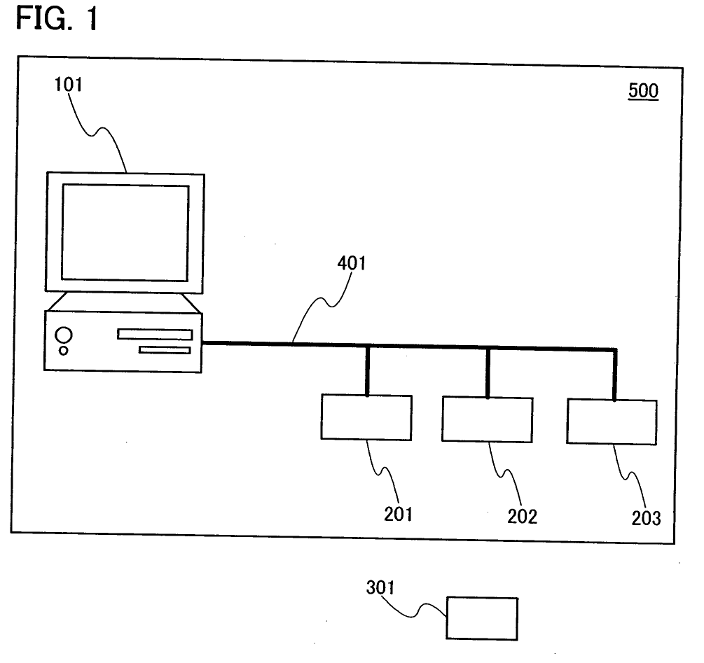

An identification system 500 includes a management server 101, plural interrogators (here, interrogators 201, 202, and 203), and a network 401 (refer to FIG. 1). The management server 101 is connected to the interrogators 201, 202, and 203 through the network 401 over which information can be transmitted and received. In addition, the interrogators 201, 202, and 203 each can transmit and receive information through wireless communication with a wireless tag 301.

The interrogator 201 may have means to control a processing concerning a communication with a wireless tag, control of the wireless tag, and data of the wireless tag, and the interrogator 201 may be called for example, a reader which reads information or a reader/writer which is provided with a reading function and a writing function. In addition, a mobile phone, a computer, and the like, each of which is with one or both of reading function and writing function, are also included.

The wireless tag 301 is a wireless IC tag which is also called an RFID (radio frequency identification) tag and the like. Tag ID which is an identification number is recorded on the wireless tag 301, and the wireless tag is used for identification of items and the like.

The network 401 is used for transmission and reception of information between the management server 101 and the interrogators 201, 202, and 203. The network 401 can be a wired network; however, the network may be a wireless network if a frequency band used by the interrogator 201 and the wireless tag 301 is different from a frequency band used by the network which does not cause interference.

The management server 101 is realized by a computer such as a personal computer.

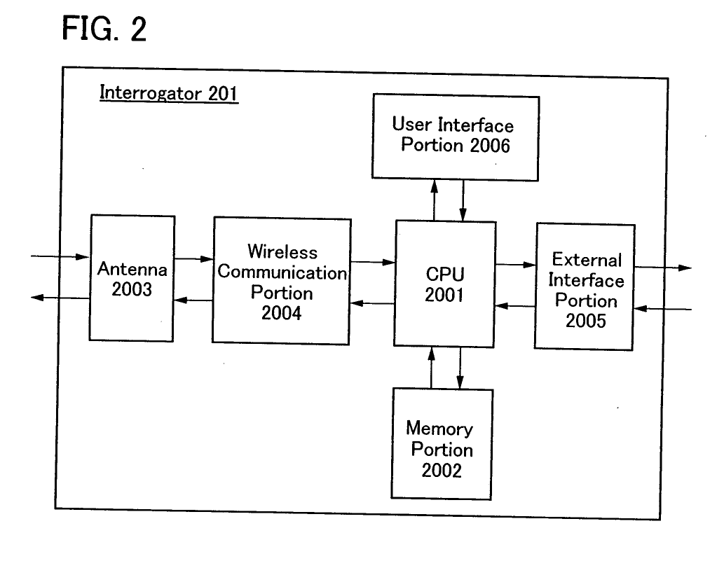

Subsequently, a specific structure of the interrogator 201 is described with reference to FIG. 2.

The interrogator 201 includes a CPU 2001 which controls the entire interrogator, a memory portion 2002 which stores various information, an antenna 2003 which transmits and receives a wireless signal, a wireless communication portion 2004 which conducts wireless communication through the antenna 2003, an external interface portion 2005 which conducts transmission and reception of information to and from outside through the network 401, and a user interface portion 2006 which receives an operation from an operator (refer to FIG. 2). Note that the interrogators 202 and 203 may each have an equivalent constitution with the interrogator 201.

The CPU 2001 executes a program which is recorded in the memory portion 2002 and controls the wireless communication portion 2004, the external interface portion 2005, and the like.

The memory portion 2002 is provided with RAM (random access memory) and ROM (read only memory). The ROM stores the program and the like executed by the CPU 2001. RAM is used by the CPU 2001 for temporal storage of data and the like. ROM may be also realized by a writable nonvolatile memory such as EEPROM (electrically erasable and programmable ROM).

The wireless communication portion 2004 has a function to transmit a wireless signal to outside via antenna 2003, a function to receive a wireless signal from the wireless tag via antenna 2003, and a carrier sense function (LBT: listen before talk) which is to detect the presence or absence of a wireless signal from another interrogator.

The external interface portion 2005 is used for connection to the network 401 and is structured to meet the specification of the network 401.

The user interface portion 2006 is used for operation of the interrogator 201 by the operator. The user interface portion 2006 transmits predetermined operation by the operator to the CPU 2001, and with the reception of the signal, the CPU 2001 performs predetermined operation in accordance with the program recorded in the memory portion 2002.

With the above structure, the interrogator 201 conducts transmission and reception of information by wireless communication to and from the wireless tag 301 which exists within predetermined range to read the information recorded in the wireless tag 301, to write information to the wireless tag 301, and the like. In addition, the interrogator 201 can detect the presence or absence of a wireless signal from another interrogator, conduct transmission and reception of information with the management server 101, and execute predetermined operation in response to operation by the operator.

Hereinafter, suitably the interrogators 201, 202, and 203 may be collectively called “all interrogators”. In addition, the interrogators 202 and 203 each have an equivalent function to that of the interrogator 201, and in the following description, a description which is applicable to all of the interrogators 201, 202, and 203 may be given with the interrogator 201 used as a representative.

Subsequently, a specific structure of the management server 101 is described with reference to drawings.

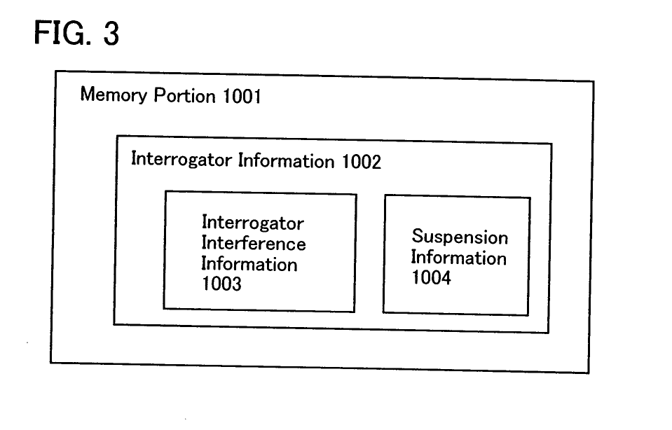

The management server 101 is provided with a memory portion 1001, and the memory portion 1001 may be structured with RAM (random access memory) (refer to FIG. 3). In addition, alternatively, the memory portion may be structured with a nonvolatile memory medium such as a hard disc drive or may be also structured with both RAM and a nonvolatile memory medium such as a hard disc drive.

Interrogator information 1002 is recorded in the memory portion 1001. In the interrogator information 1002, information regarding an identifier, address on the network, and whether the interrogators possess the right to conduct wireless communication, of the interrogator among the interrogators 201, 202, and 203 which have applied for registration as described below, is recorded. In addition, in the interrogator information 1002, interrogator interference information 1003 and suspension information 1004 are recorded.

The identifier may be any form as long as it can identify the interrogator uniquely. In addition, as the address on the network, for example, IP address can be used depending on the specification of the network 401; however, one that can identify the interrogator over the network may be suitably selected in accordance with the specification of the network 401. In addition, the right to conduct wireless communication is a right the interrogators 201, 202, and 203 each apply to the management server 101 before conducting wireless communication and the management server 101 imparts to the interrogators which have performed application, and the interrogators 201, 202, and 203 can only transmit wireless signals when in possession of the right to conduct wireless communication.

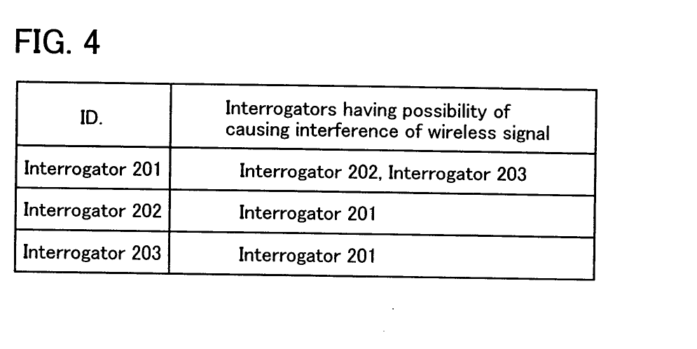

The interrogator interference information 1003 is a record whether a wireless signal from which interrogators may interfere with that from taken by a method described below. For example, when the interrogators 201, 202, and 203 are registered in the identification system and the wireless signal transmitted by the interrogator 201 may interfere with each wireless signal of the interrogators 202 and 203, the interrogator interference information 1003 can have the content shown in FIG. 4. Note that the form of information shown in FIG. 4 is one example in embodiment mode 1, and any form that fulfills equivalent function may be taken.

The suspension information 1004 records, that the management server 101 suspends the right to conduct wireless communication when the management server 101 receives the application for a right to conduct wireless communication and suspends the imparting of the right to conduct wireless communication.

Note that information recorded in the above interrogator information 1002 is one example of embodiment mode 1, and if equal function can be fulfilled, other information may be recorded to realize the interrogator information 1002.

Note that in the following description, the interrogator which is registered in the management server 101 is the interrogator whose information is recorded in the interrogator information 1002.

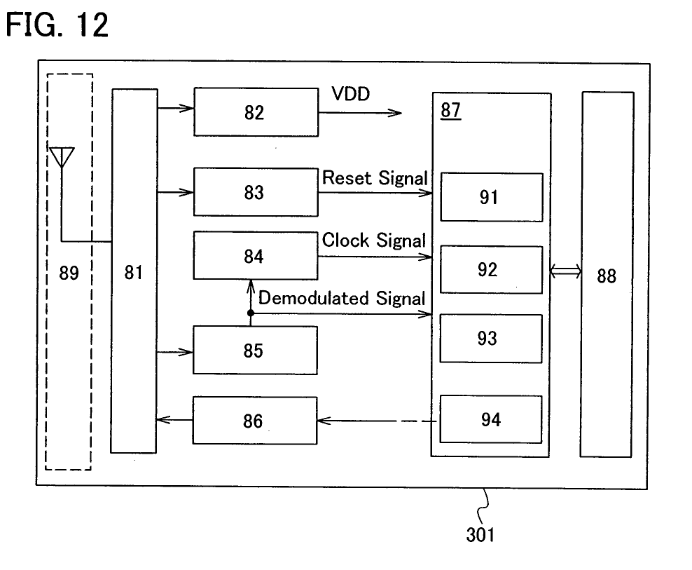

Subsequently, one example of the structure of the wireless tag 301 is described with reference to FIG. 12.

The wireless tag 301 has a function to communicate data without contact, and includes a high frequency circuit 81, a power supply circuit 82, a reset circuit 83, a clock generator circuit 84, a data demodulation circuit 85, a data modulation circuit 86, a control circuit 87 controlling other circuits, a memory circuit 88, and an antenna 89 (FIG. 12). The high frequency circuit 81 receives a signal from the antenna 89, and it is a circuit outputting a signal received from the data modulation circuit 86 to the antenna 89, and the power supply circuit 82 is a circuit generating power supply potential from a received signal, and the reset circuit 83 is a circuit generating a reset signal, and the clock generator circuit 84 is a circuit generating various clock signal based on receive signal input from the antenna 89, and the data demodulation circuit 85 is a circuit which demodulates a receive signal, and outputs the demodulated signal to the control circuit 87, and the data modulation circuit 86 is a circuit which modulates a signal received from the control circuit 87. In addition, for example, for the control circuit 87, a code extraction circuit 91, a code judgment circuit 92, a CRC judgment circuit 93, and an output unit circuit 94 are provided. In addition, the code extraction circuit 91 is a circuit which extracts each of plural codes included in the command that has been transmitted to control circuit 87, and the code judgment circuit 92 is a circuit which compares an extracted code and code corresponding to reference, and determines the content of a command, and the CRC judgment circuit 93 is a circuit which detects the presence of transmission error based on a determined code.

An example of operation of the wireless tag 301 is described below. At first, a wireless signal from the interrogator 201 is received by the antenna 89. The wireless signal is transmitted to the power supply circuit 82 through the high frequency circuit 81, and high power supply potential (hereinafter referred to as VDD) is generated. VDD is supplied to each circuit which the wireless tag 301 has. In addition, a signal transmitted to the data demodulation circuit 85 through the high frequency circuit 81 is demodulated (hereinafter, a demodulated signal). Further still, the signal which passes the reset circuit 83 and the clock generator circuit 84 through the high frequency circuit 81, and the demodulated signal are transmitted to the control circuit 87. The signal transmitted to the control circuit 87 is analyzed by the code extraction circuit 91, the code judgment circuit 92, the CRC judgment circuit 93, and the like. And, in accordance with the analyzed signal, information of the wireless tag 301 stored in the memory circuit 88 is output. The output information of the wireless tag 301 is encoded through the output unit circuit 94. In addition, the encoded information of the wireless tag 301 passes through the data modulation circuit 86 and is transmitted as a wireless signal by the antenna 89. Note that in a plurality of circuits structuring the wireless tag 301, low power supply potential (hereinafter VSS) is common, and VSS can be set to GND.

As thus described, data of the wireless tag 301 can be read by transmission of a signal from the interrogator 201 to the wireless tag 301, and reception of a signal transmitted from the wireless tag 301 by the interrogator 201. Note that the wireless tag 301 may be a type which performs supply of a power supply voltage to each circuit by an electromagnetic wave without being equipped with a power supply (battery), and may alternatively be a type which is equipped with a power supply (battery) and supplies a power supply voltage by an electromagnetic wave and a power supply (battery) to each circuit.

Subsequently, functions which the management server 101 and the interrogator 201 are provided with are described. In addition, here the function which the interrogator 201 is provided with is described; however, the interrogator 202 and the interrogator 203 have the equivalent structure to the structure of the interrogator 201 and have the equivalent function to the function herein described.

The interrogator 201 includes functions to apply to the management server 101 for registration, to apply to the management server 101 for cancellation of registration, to apply to the management server 101 for a right to conduct wireless communication, to start wireless communication when the right to conduct wireless communication is imparted, to return the right to conduct wireless communication to the management server 101, to perform carrier sense, and to transmit the result of carrier sense to the management server 101.

The function to apply to the management server 101 for registration is realized in such a way that the interrogator 201 transmits information that application for registration to the management server 101 is completed and receives information notifying that the registration is completed from the management server 101.

The function to apply to the management server 101 for cancellation of registration is realized in such a way that the interrogator 201 transmits information including a content of application for cancellation of registration to the management server 101 and receives information notifying that the cancellation of registration is completed from the management server 101.

The function to apply to the management server 101 for a right to conduct wireless communication is realized in such a way that the interrogator 201 transmits information including a content of application for the right to conduct wireless communication to the management server 101.

The function to start wireless communication when the right to conduct wireless communication is imparted is realized in such a way that after the interrogator 201 transmits information including a content of application for the right to conduct wireless communication, the interrogator 201 stands by to receive information including a content of imparting the right to conduct wireless communication from the management server 101 and transmits a predetermined wireless signal after information including a content of imparting the right to conduct wireless communication from the management server 101.

The function to return the right to conduct wireless communication to the management server 101 is realized in such a way that the interrogator 201 transmits information including a content of return of the right to conduct wireless communication to the management server 101 and receives information that return of the right to conduct wireless communication is completed from the management server 101.

The function to perform carrier sense is realized in such a way that the CPU 2001 causes the wireless communication portion 2004 to perform carrier sense and records the result of carrier sense in the memory portion 2002.

The function to transmit the result of carrier sense to the management server 101 is realized by transmitting information including the result of carrier sense recorded in the memory portion 2002 to the management server 101.

In addition, the management server 101 has functions to register the interrogator 201 in the interrogator information, to deregister the interrogator 201, to impart the right to conduct wireless communication to the interrogator 201, to suspend the imparting of the right to conduct wireless communication to the interrogator 201, to impart the right to conduct wireless communication that is suspended to the interrogator 201, to make the interrogator 201 transmit and stop a wireless signal, to make the interrogator 201 start and end carrier sense, to make the interrogator 201 transmit the result of the carrier sense, and to record the result of the carrier sense to the interrogator interference information 1003.

The function to register the interrogator 201 to the interrogator information is realized in such a way that when information including a content of registration application is received from the interrogator 201, information regarding the interrogator 201 is recorded to the interrogator information 1002 using the received information, and information that registration to the interrogator 201 is completed is transmitted to the interrogator 201.

The function to deregister the interrogator 201 is realized in such a way that when information including a content of application for cancellation of registration is received from the interrogator 201, information regarding the interrogator 201 is deleted from the interrogator information 1002, the interrogator information 1003, and the suspension information 1004 using the received information and information notifying that the cancellation of registration is completed is transmitted to the interrogator 201.

The function to impart the right to conduct wireless communication to the interrogator 201 is realized in such a way that the management server 101 transmits information including a content of imparting of the right to conduct wireless communication to the interrogator 201 and the information that the interrogator 201 has the right to conduct wireless communication is recorded in the interrogator information 1002.

The function to suspend imparting of the right to conduct wireless communication to the interrogator 201 is realized in such a way that when receiving information including a content of application for the right to conduct wireless communication from the interrogator 201, the management server 101 records the information that there has been an application for the right to conduct wireless communication from the interrogator 201 on the suspension information 1004 and information to impart the right to conduct wireless communication is not transmitted to the interrogator 201.

The function to impart the right to conduct wireless communication which is suspended to the interrogator 201 is realized in such a way that when the information that there is an application for the right to conduct wireless communication from the interrogator 201 is recorded in the suspension information 201 and the management server 101 receives information including the content of returning the right to conduct wireless communication from the interrogators that might cause interference of wireless signals with the interrogator 201, information to impart the right to conduct wireless communication is transmitted to the interrogator 201, and the information that there is an application for the right to conduct wireless communication from the interrogator 201 is deleted from the suspension information 1004 and the information that the interrogator 201 has the right to conduct wireless communication is recorded in the interrogator information 1002.

The function to cause the interrogator 201 to transmit and stop a wireless signal is realized in such a way that the management server 101 transmits information including the command to transmit and stop the wireless signal to the interrogator 201.

The function to make the interrogator 201 start and end carrier sense is realized in such a way that the management server 101 transmits information including the command to start and end carrier sense to the interrogator 201.

The function to make the interrogator 201 transmit the result of carrier sense is realized in such a way that the management server 101 transmits information including the command to transmit the result of carrier sense to the interrogator 201.

The function to record the result of carrier sense in the interrogator interference information 1003 is realized in such a way that the management server 101 receives information including the result of carrier sense from the interrogator 201 and the information is recorded in the interrogator interference information 1003 in predetermined form using the information received.

Note that in addition to the above functions, functions other than these described here may be added to the management server 101 and the interrogator 201 if necessary.

Here, the functions of the management server 101 to suspend the right to conduct wireless communication and imparts the right to conduct wireless communication that was suspended is further described.

First, a case in which the interrogator interference information 1003 has the content shown in FIG. 4 where wireless signal of the interrogators 201 may interfere with wireless signal each of the interrogator 202 and 203, and wireless signal of the interrogator 202 does not interfere with wireless signal of the interrogator 203, and only the interrogator 201 has the right to conduct wireless communication is described.

Here, when there is an application for the right to conduct wireless communication from the interrogator 202, the management server 101 suspends the imparting of the right to conduct wireless communication to the interrogator 202, since there might be an interference of wireless signals with the interrogator 201, if the management server 101 imparts the right to conduct wireless communication to the interrogator 202. Here, if further there is an application for the right to conduct wireless communication from the interrogator 203, since if the management server 101 imparts the right to conduct wireless communication to the interrogator 203, there might be an interference of wireless signal with the interrogator 201, the imparting of the right to conduct wireless communication to the interrogator 203 is also suspended. As thus described, the management server 101 continues to suspend the imparting of the right to conduct wireless communication when there might be an interference of wireless signals.

Here, when the right to conduct wireless communication is returned from the interrogator 201, the management server 101 imparts the right to conduct wireless communication to the interrogators 202 and 203 which has applied for the right to conduct wireless communication. In the case shown in FIG. 4, since there is no possibility of causing interference even if the interrogator 202 and the interrogator 203 conduct wireless communication simultaneously, the right to conduct wireless communication is simultaneously imparted to the interrogator 202 and the interrogator 203.

Subsequently, a case in which the interrogator interference information 1003 has the content shown in FIG. 4, and the interrogator 202 and the interrogator 203 have the right to conduct wireless communication is described.

Here, since the interrogator 201 might cause the interference of wireless signals with the interrogator 202 and the interrogator 203 if the interrogator 201 applies for the right to conduct wireless communication, the management server 101 suspends the imparting of the right to conduct wireless communication to the interrogator 201.

Here, even when the interrogator 202 returns the right to conduct wireless communication, the management server 101 does not impart the right to conduct wireless communication to the interrogator 201 and continues the suspension. The reason is that even if the interrogator 202 returns the right to conduct wireless communication, the interrogator 203 which might interfere with the interrogator 201 still has the right to conduct wireless communication.

Subsequently, as the interrogator 203 returns the right to conduct wireless communication to the management server 101, the interrogators which might interfere with the interrogator 201 do not have the right to conduct wireless communication, the management server 101 imparts the right to conduct wireless communication to the interrogator 201.

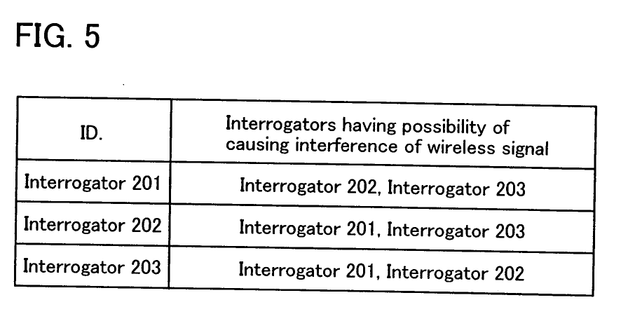

Subsequently, a case in which the interrogator interference information 1003 has the content shown in FIG. 5 and only the interrogator 201 has the right to conduct wireless communication is described.

Here, when there is an application for the right to conduct wireless communication from the interrogator 202, the management server 101 suspends the imparting of the right to conduct wireless communication, since the interrogator 202 might cause the interference of wireless signals with the interrogator 201. Here, if further there is an application for the right to conduct wireless communication from the interrogator 203, the management server 101 also suspends the imparting of the right to conduct wireless communication to the interrogator 203, since there might be an interference of wireless signal with the interrogator 201.

Here, when the right to conduct wireless communication is returned from the interrogator 201, the management server 101 imparts the right to conduct wireless communication to either one of the interrogator 202 or the interrogator 203, since wireless signals of the interrogator 202 and the interrogator 203 might interfere if the right to conduct wireless communication is imparted to the interrogator 202 and the interrogator 203 simultaneously. In doing so, various methods can be used for the method for selecting which interrogator the right to conduct wireless communication is to be imparted to. For example, a method for imparting the right to conduct wireless communication first to the interrogator (here the interrogator 202) which has applied for the right to conduct wireless communication to the management server 101 earlier can be used. In addition, as another method, a method in which the interrogator information 1002 is set to be able to record the priorities of interrogators registered in the interrogator information 1002, and an operator imparts a priority to each interrogator, and when the management server 101 imparts the right to conduct wireless communication, the right to conduct wireless communication is imparted an interrogator with higher priority on ahead is used.

As thus described, the management server 101 performs the imparting of the right to conduct wireless communication and suspension of the right to conduct wireless communication, and prevent the interference of wireless signals among interrogators registered in the management server 101.

### Embodiment Mode 2

In embodiment mode 2, one example of an identification method using the identification system described in embodiment mode 1 is described.

First, steps in which an interrogator is registered in the management server 101 are described. Note that here a case in which the interrogator 202 and the interrogator 203 are already registered in the management server 101 and unregistered interrogator 201 is registered to the management server 101 is described.

The interrogator 201, when setting in a proper place and connected to the network 401, applies to the management server 101 for registration.

When the management server 101 receives a registration application from the interrogator 201, the management server 101 records the information regarding the interrogator 201 to the interrogator information 1002 in predetermined form and notifies the interrogator 201 that the registration is completed.

With the above steps, the registration of the interrogator 201 to the management server 101 is completed. The interrogator 201, after the registration is completed, starts predetermined processing in accordance with the program recorded in the memory portion 2002. Note that hereinafter the management server 101 is described as the interrogator 201, 202, and 203 being registered therein.

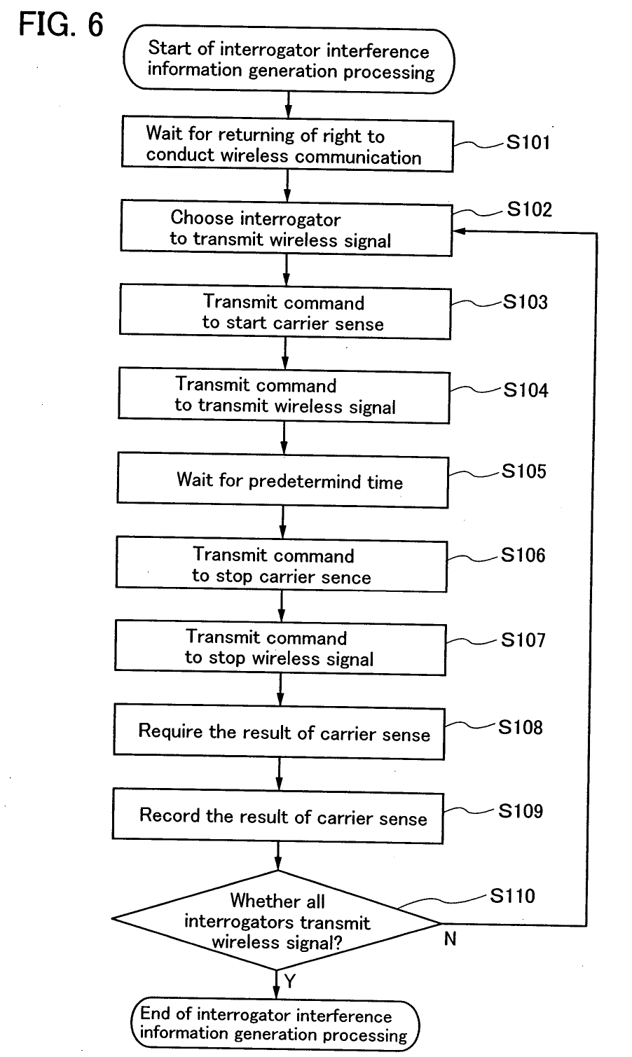

As thus described, when the interrogator 201 is newly registered in the management server 101, the interrogator 201 might cause interference of wireless signals with an interrogator which has been already registered to the management server 101. Therefore, the management server 101 continues to generate the interrogator interference information 1003. Described below with reference to a flow chart in FIG. 6 is interrogator interference information generation processing which is performed when the management server 101 makes the interrogator interference information 1003.

First, the management server 101 waits until the right to conduct wireless communication is returned from all interrogators (step S101). In other words, the management server 101 refers to the interrogator information 1002 and when the information that there is an interrogator having the right to conduct wireless communication is recorded in the interrogator information 1002, the management server 101 waits until all the right to conduct wireless communication is returned. When no interrogator has the right to conduct wireless communication, the management server 101 does not stand by and proceeds to the next step. In addition, the management server 101 suspends the imparting of the right to conduct wireless communication when there is an application for the right to conduct wireless communication from an interrogator which is registered to the management server 101 from this step until generating of the interrogator interference information 1003 ends. By this, until the making of the interrogator information 1003 ends, all interrogators do not transmit wireless signals unless ordered by the management server 101.

The management server 101, after it is confirmed that all the interrogators do not have the right to conduct wireless communication, chooses one interrogator which has not yet transmitted a wireless signal in step S104 from the interrogators registered to the management server 101 (step S102).

Subsequently, the management server 101 transmits a command to start carrier sense to all the interrogators other than the interrogator chosen in step S102 and causes carrier sense to be started (step S103).

Subsequently, the management server 101 transmits a command to transmit a wireless signal to the interrogator chosen in step S102 and causes the wireless signal to be transmitted (step S104).

Subsequently, the management server 101 stands by until predetermined time is passes (step S105).

The management server 101, after the passage of predetermined time, transmits a command to stop carrier sense to all the interrogators other than the interrogator chosen in step S102 for carrier sense to be stopped (step S106).

Subsequently, the management server 101 transmits a command to stop the wireless signal to the interrogator chosen in step S102 and causes the wireless signal to be stopped (step S107).

Subsequently, the management server 101 transmits a command to transmit the result of carrier sense to all the interrogators other than the interrogator chosen in step S102 and causes the result of carrier sense to be transmitted to the management server 101 (step S108).

Subsequently, the management server 101 records the result of carrier sense received in step S108 in the interrogator interference information 1003 (step S109).

Subsequently, the management server 101 check whether all interrogators registered in the management server101 are chosen in step S102 (step S110). In step S110, if it is confirmed that all the interrogators registered to the management server 101 are chosen in step S102, interrogator interference information generation processing is ended, otherwise the processing goes back to step S102.

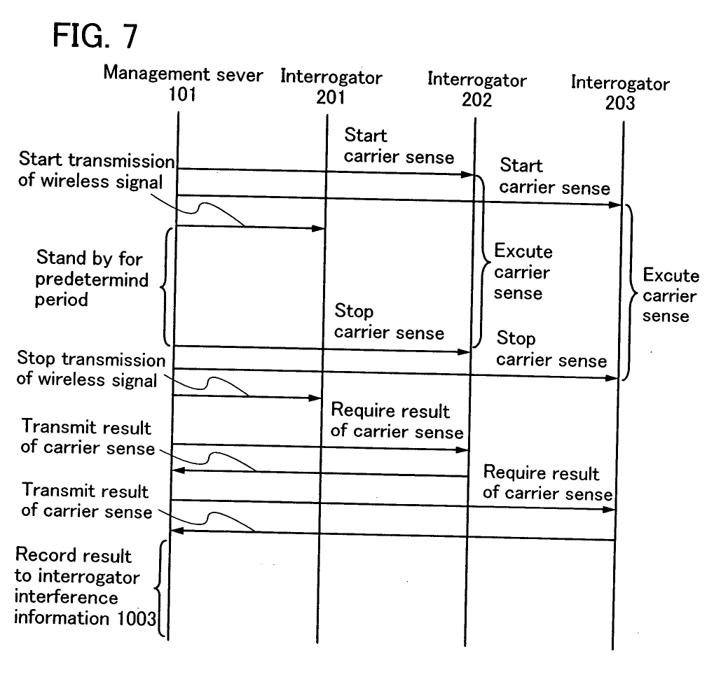

Here, the operation of the management server 101 and the interrogators 201, 202, and 203 from step S103 to step S109 in a case where the interrogator 201 is chosen in step S102, is shown in FIG. 7 as a sequence diagram.

When the interrogator 201 is chosen in step S102, the management server 101 transmits a command to start carrier sense to the interrogators 202 and 203, and the interrogators 202 and 203 start carrier sense. In addition, the management server 101 transmits a command to transmit a wireless signal to the interrogator 201, and the interrogator 201 starts the transmission of a wireless signal. Subsequently, the management server 101 stands by for a predetermined period of time. After the passage of the predetermined time, the management server 101 transmits a command to stop carrier sense to the interrogators 202 and 203, and the interrogators 202 and 203 stop carrier sense. In addition, the management server 101 transmits a command to stop the transmission of the wireless signal to the interrogator 201, and the interrogator 201 stops the transmission of wireless signal. Subsequently, the management server 101 require the result of carrier sense of the interrogators 202 and 203, and the interrogators 202 and 203 each transmit the result of carrier sense to the management server 101. Subsequently, the management server 101 records the result of carrier sense received from the interrogators 202 and 203 to the interrogator interference information 1003.

As described above, the management server 101 generates the interrogator interference information 1003. By generating the interrogator interference information 1003 with such steps, a combination of interrogators that causes the interference of wireless signals is recorded in the interrogator interference information 1003. For example, in generating the interrogator interference information 1003, while the interrogator 202 performs carrier sense and the interrogator 201 transmits a wireless signal, the interrogator 202 detects the wireless signal. This means that the wireless signal from the interrogator 201 reaches the position where the interrogator 201 exists, which indicates that when the interrogator 201 and the interrogator 202 simultaneously transmit wireless signals, the interference of wireless signals is caused. In such a case, the management server 101 records the interrogator 202 as an interrogator which might interfere with the interrogator 201 in the interrogator interference information 1003. As a result, it is achieved that the management server 101 does not impart the right to conduct wireless communication to the interrogator 201 and the interrogator 202 simultaneously.

As thus described, in the identification system 500 in embodiment mode 2, when an interrogator is newly added to the identification system 500, the management server 101 generates the interrogator interference information 1003 to have the information of a combination of interrogators that causes the interference.

In addition, the management server 101 is set to be able to execute the generating of the interrogator interference information 1003 at any time by receiving predetermined operation by an operator. For example, when the placement of the interrogators registered to the management server 101 is changed, a combination of interrogators which causes interference is changed; therefore, there is a need to regenerate the interrogator interference information 1003. In such a case, the operator can make the management server 101 regenerate the interrogator interference information 1003 and make the management server 101 have the information of the combination of the interrogators that causes the interference. In addition, the management server 101 may be also set to perform the making of the interrogator interference information 1003 automatically after predetermined times passes.

Below described is a procedure in which under the management of the management server 101, the interrogator 201 conducts wireless communication with a wireless tag while avoiding the interference of wireless signals.

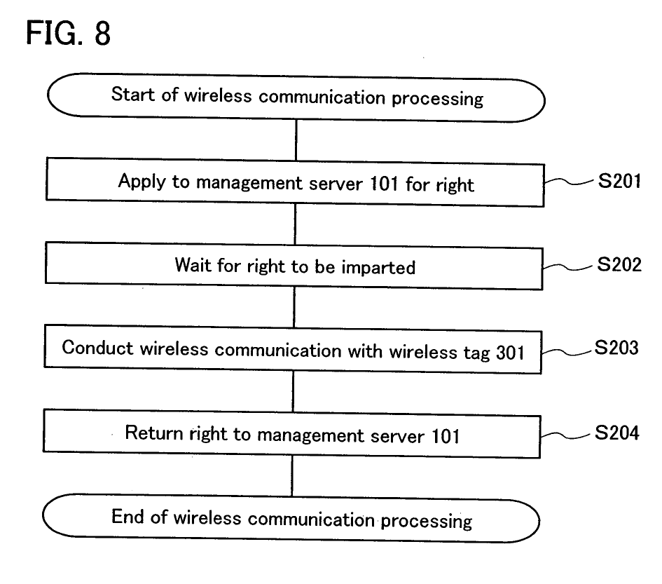

First, wireless communication processing when the interrogator 201 conducts wireless communication with the wireless tag 301 is described using a flow chart in FIG. 8.

The interrogator 201 applies to the management server 101 for the right to conduct wireless communication when the interrogator 201 needs wireless communication with the wireless tag 301 while executing predetermined processing in accordance with the program that is recorded therein (step S201).

The interrogator 201, after application to the management server 101 for the right to conduct wireless communication waits for the imparting of right to conduct wireless communication from the management server 101 (step S202).

The interrogator 201, after the right to conduct wireless communication is imparted, conducts wireless communication with the wireless tag 301 (step S203).

The interrogator 201, after the wireless communication with the wireless tag 301 is completed, returns the right to conduct wireless communication to the management server 101 (step S204).

As described above, the interrogator 201 executes wireless communication prossecing, and conducts wireless communication with the wireless tag 301.

On the other hand, a processing of the management server when the interrogator 201 conducts wireless communication with the wireless tag 301 is described below.

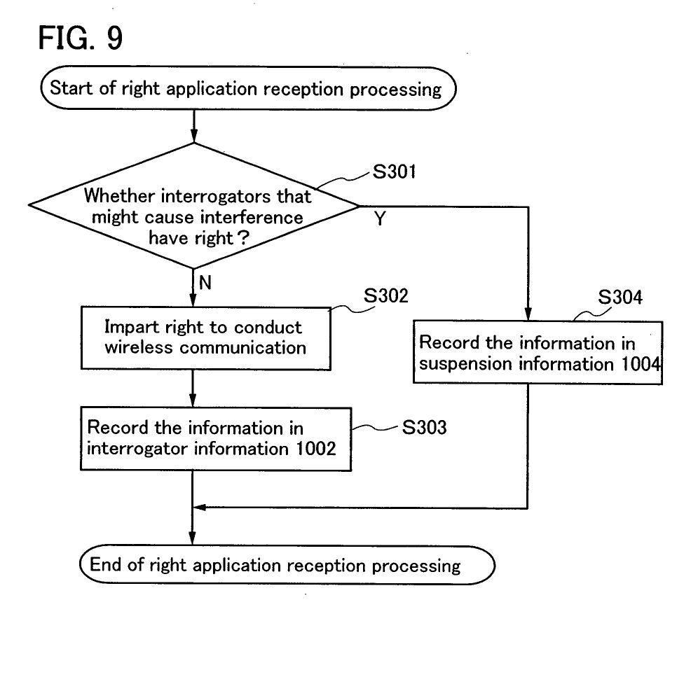

First, right application reception processing executed by the management server 101 when the interrogator 201 applies to the management server 101 for the right to conduct wireless communication is described in accordance with a flow chart in FIG. 9.

The management server 101, after receiving an application for the right to conduct wireless communication from the interrogator 201, refers to the interrogator information 1002 and the interrogator interference information 1003 and check whether interrogators that might cause interference have the right to conduct wireless communication (step S301). When there are no interrogators that might interfere with the interrogator 201 or it is confirmed that the interrogators that might interfere with the interrogator 201 do not have the right to conduct wireless communication, the processing proceeds to step S302. When it is confirmed that an interrogator that might interfere with the interrogator 201 has the right to conduct wireless communication, the processing proceeds to step S304.

In step S302, the management server 101 imparts the right to conduct wireless communication to the interrogator 201. At this point, it is secured that interrogators that might interfere with the interrogator 201 do not have the right to conduct wireless communication and do not transmit a wireless signal; therefore, the interrogator 201 can conduct wireless communication with the wireless tag 301 without causing interference of wireless signals with another interrogator.

After the right to conduct wireless communication is imparted to the interrogator 201 in step S302, the management server 101 records in the interrogator information 1002 that the right to conduct wireless communication is imparted to the interrogator 201 (step S303), and the right application reception processing is ended.

In step S304, the management server 101 records in the suspension information 1004 that there is an application for the right to conduct wireless communication from the interrogator 201, and the right application reception processing is ended.

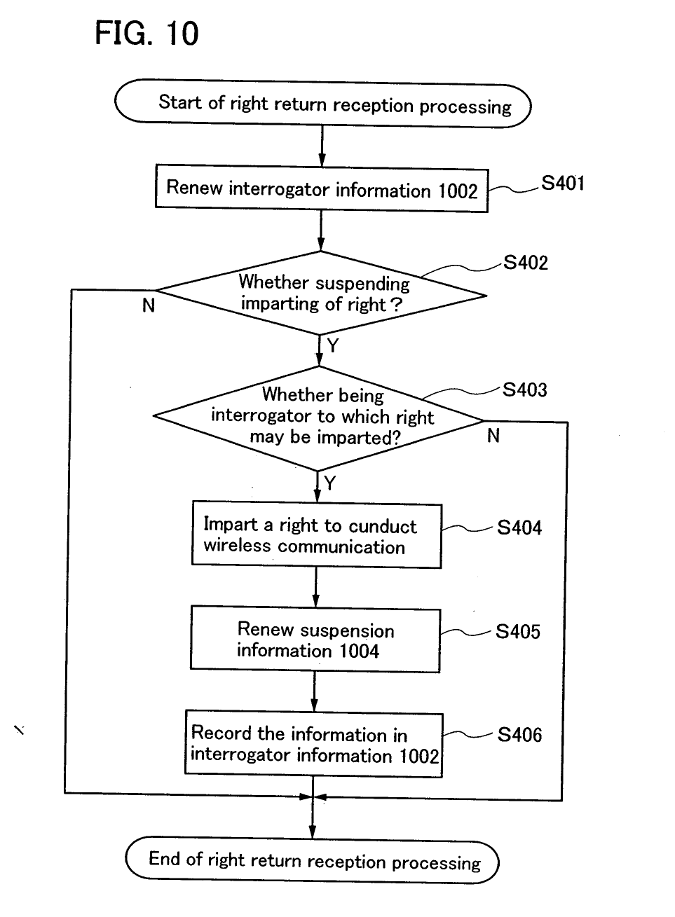

Subsequently, right return reception processing which is executed by the management server 101 when the interrogator 201 returns the right to conduct wireless communication to the management server 101 is described in accordance with a flow chart shown in FIG. 10.

First, when the right to conduct wireless communication is returned from the interrogator 201, the management server 101 renews the interrogator information 1002 (step S401). In other words, the information that the interrogator 201 has the right to conduct wireless communication is deleted from the interrogator information 1002.

Subsequently, the management server 101 refers to the suspension information 1004 and confirms whether the imparting of the right to conduct wireless communication is suspended or not (step S402). When the right to conduct wireless communication is suspended, step proceeds to step S403, and otherwise, the right return processing is ended.

In step S403, the management server 101 refers to the interrogator information 1002, the interrogator interference information 1003, and the suspend information 1004 to confirm if there is an interrogator to which the right to conduct wireless communication may be imparted among the interrogators to which the imparting of the right to conduct wireless communication is suspended. Here, the interrogator to which the right to conduct wireless communication may be imparted is an interrogator which does not cause interference with interrogators which have the right to conduct wireless communication. In step S403, if it is confirmed that there is an interrogator to which the right to conduct wireless communication may be imparted among interrogators to which the imparting of the right to conduct wireless communication is suspended, the processing proceeds to step S404, and otherwise, the right return reception processing is ended.

In step S404, the management server 101 imparts the right to conduct wireless communication to an interrogator to which the right to conduct wireless communication can be imparted among the interrogators to which the imparting of the right to conduct wireless communication is suspended. Note that when there are a plurality of interrogators which are suspended the right to conduct wireless communication, if there is no possibility of interference caused by the plurality of interrogators, the right to conduct wireless communication can be imparted to the plurality of interrogators simultaneously.

On the other hand, when there might be interference among a plurality of interrogators in conducting wireless communication, the right to conduct wireless communication is not simultaneously imparted to interrogators that might cause interference with each other. In this case, there are various methods for imparting the right to conduct wireless communication to interrogators that might cause interference with each other. For example, there is a method in which an interrogator that applied for the right to conduct wireless communication first among target interrogators is imparted. Also, there is another method in which each interrogator is given a priority beforehand, and the right to conduct wireless communication is imparted to an interrogator with high priority among the target interrogators on ahead.

In step S405, the management server 101 renews the suspension information 1004. In other words, the management server 101 deletes the information from the suspension information 1004, that the imparting of the right to conduct wireless communication to the interrogator to which the right to conduct wireless communication was imparted in step S404 is suspended.

In step S406, the management server 101 records the information, on the interrogator information 1002, that the interrogator to which the right to conduct wireless communication was imparted in step S404 has the right to conduct wireless communication.

After the above steps, the management server 101 ends right return reception processing.

In embodiment mode 2, since the interrogator 201 conducts wireless communication with the wireless tag 301 with the method described above, the interrogator 201 can conduct wireless communication with the wireless tag 301 while avoiding the interference of wireless signals with other interrogators. This is because when the interrogator 201 applies for the right to conduct wireless communication in an attempt to execute wireless communication and an interrogator that might interfere with the interrogator 201 has the right to conduct wireless communication, the interrogator 201 needs to wait for the imparting of the right to conduct wireless communication by the management server 101 and does not transmit a wireless communication. In addition, this is also because when the interrogator 201 to which the right to conduct wireless communication is imparted from the management server 101, and starts wireless communication with the wireless tag 301, an interrogator that might interfere with the interrogator 201 does not have the right to conduct wireless communication and does not transmit a wireless signal.

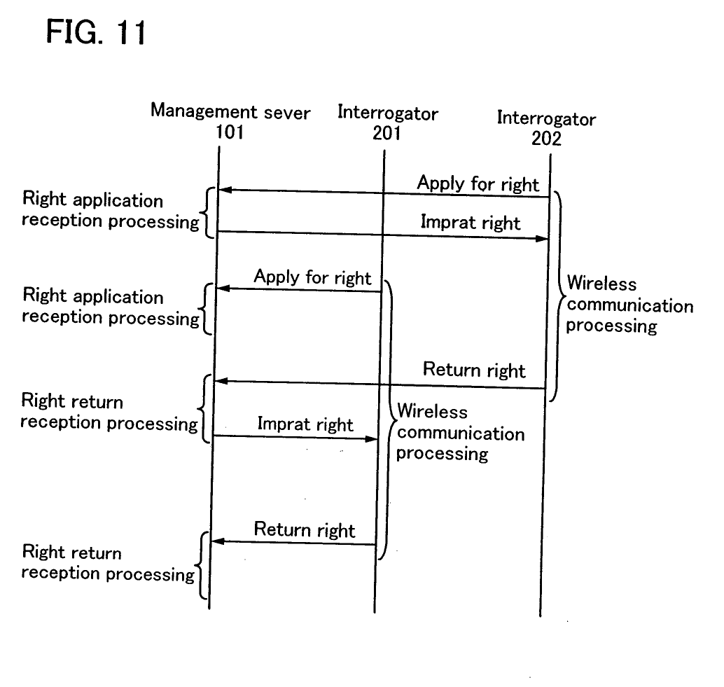

Here, FIG. 11 shows as a sequence diagram, one example of operation of the management server 101, the interrogator 201, and the interrogator 202 in a case where the interrogator interference information 1003 has the content shown in FIG. 4 is shown as a sequence diagram in FIG. 11. In a case of the content in FIG. 4, the interrogator 201 and the interrogator 202 might cause the interference of wireless signals. In addition, here, at first, all the interrogators do not have the right to conduct wireless communication.

First, when the interrogator 202 starts wireless communication processing, the interrogator 202 applies to the management server 101 for the right to conduct wireless communication, and the management server 101 which has received the application starts the right application reception processing. At this point, the interrogator (the interrogator 201) which might interfere with the interrogator 202 does not have the right to conduct wireless communication; therefore, the management server 101 imparts the right to conduct wireless communication to the interrogator 202, and ends the right application reception processing.

The interrogator 202 starts wireless communication with the wireless tag 301 when the right to conduct wireless communication is imparted from the management server 101.

Here, when the interrogator 201 starts wireless communication processing, the interrogator 201 applies to the management server 101 for the right to conduct wireless communication and the management server 101 starts the right application reception processing. At this point, since the interrogator (here the interrogator 202) which might interfere with the interrogator 201 has the right to conduct wireless communication; therefore, the management server 101 suspends the imparting of the right to conduct wireless communication to the interrogator 201, and the right application reception processing is ended. The interrogator 201 waits for the imparting of the right to conduct wireless communication from the management server 101.

The interrogator 202 returns the right to conduct wireless communication to the management server 101 after the wireless communication with the wireless tag 301 is ended. The management server 101 starts the right return reception processing when the right to conduct wireless communication is returned from the interrogator 202, and the interrogator 202 ends the wireless communication processing. The management server 101 confirms in the right return reception processing that the imparting of the right to conduct wireless communication to the interrogator 201 is suspended and the interrogators (here the interrogator 202 and the interrogator 203) that might interfere with the interrogator 201 do not have the right to conduct wireless communication, and the management server 101 imparts the right to conduct wireless communication to the interrogator 201 and ends the right return reception processing is ended.

The interrogator 201 conducts wireless communication with the wireless tag 301 when the right to conduct wireless communication is imparted from the management server 101.

The interrogator 201 returns the right to conduct wireless communication to the management server 101 when the wireless communication with the wireless tag 301 is ended. The management server 101 starts the right return reception process when the right to conduct wireless communication is returned from the interrogator 201, and the interrogator 201 ends the wireless communication processing. The management server 101 confirms that in the process of reception of return of right, the imparting of the right to conduct wireless communication is not suspended, and ends the right return reception processing.

Interrogator that is registered to the management server 101 conducts wireless communication in such a way, so that wireless communication with the wireless tag 301 can be conducted without causing interference with another interrogator registered to the management server 101.

In the identification system 500, when an operator intends not to use the interrogator 201, registration of the interrogator 201 can be easily cancelled from the management server 101. A procedure for canceling the registration of the interrogator 201 from the management server101 is described below.

First, the operator performs predetermined operation on the user interface portion 2006 of the interrogator 201 for cancellation of registration.

When the operator performs predetermined operation of the user interface portion 2006 for cancellation of registration, the interrogator 201 performs application for cancellation of registration to the interrogator 201.

The management server 101, when receives the application for cancellation of registration from the interrogator 201, deletes information regarding the interrogator 201 from each of the interrogator information 1002, the interrogator interference information 1003, and the suspension information 1004 and notifies the interrogator 201 that cancellation of registration is completed.

Through the above procedure, registration of the interrogator 201 is deleted from the management server 101. In the identification system 500, after the interrogator 201 is deregistered from the management server 101 in such a way, the operator can freely remove the interrogator 201.

As above mentioned, in the identification system provided by the present invention, under the management of the management server, a plurality of interrogators can conduct wireless communication with a wireless tag while avoiding interference of wireless signals; therefore, the operator can set the interrogators without being concerned about the interference of wireless signals when the operators set the interrogators, and a plurality of interrogators can be paced adjacently with each other. In addition, in the identification system provided by the present invention, since the operator can perform addition of an interrogator to the identification system and deletion of an interrogator from the identification system with easy operation, the management of the identification system becomes easy.

This application is based on Japanese Patent Application serial no. 2006-124748 filed in Japan Patent Office on Apr. 28, 2006, the entire contents of which are hereby incorporated by reference.

What is claimed is:

1. An identification method in which an interrogator identifies a wireless tag under a management of a management server comprising:
applying for a registration of the interrogator to the management server,
performing the registration of the interrogator,
making an interrogator information,
controlling start of carrier sense performed by the interrogator,
controlling end of carrier sense performed by the interrogator,
controlling transmission of a wireless signal performed by the interrogator,
controlling stop of a wireless signal performed by the interrogator,
transmitting the result of carrier sense to the management server, and
making an interrogator interference information.

2. An identification method in which an interrogator identifies a wireless tag under a management of a management server comprising:
applying to the management server for a right to conduct wireless communication,
imparting the right to conduct wireless communication to the interrogator,
conducting wireless communication with the wireless tag,
returning the right to conduct wireless communication to the management server,
applying to the management server for cancellation of registration, and
deregistering the interrogator.

3. An identification method according to claim 2 further comprising:
suspending imparting of the right to conduct wireless communication to the interrogator, and
making a suspension information.

4. An identification method according to claim 1 further comprising:
applying to the management server for a right to conduct wireless communication,
imparting the right to conduct wireless communication to the interrogator,
conducting wireless communication with the wireless tag,
returning the right to conduct wireless communication to the management server,
applying to the management server for cancellation of registration, and
deregistering the interrogator.

5. An identification method according to claim 4 further comprising:
suspending imparting of the right to conduct wireless communication to the interrogator, and
making a suspension information.

6. An identification system comprising:
an interrogator which conducts wireless communication with a wireless tag and a management server which manages the interrogator,
wherein the interrogator includes:
a means for performing registration application to the management server;
a means for performing carrier sense;
a means for transmitting a result of the carrier sense to the management server;
a means for applying to the management server for a right to conduct wireless communication;
a means for starting wireless communication by obtaining the right to conduct wireless communication;
a means for returning the right to conduct wireless communication to the management server when wireless communication with the wireless tag is ended; and
a means for applying to the management server for cancellation of registration, and
wherein the management server includes:
a means for performing a registration of the interrogator;
a means for making an interrogator information;
a means for making the interrogator transmit and stop a wireless signal;
a means for making the interrogator start and stop carrier sense;
a means for making the interrogator transmit a result of carrier sense;
a means for making interrogator interference information;
a means for imparting the right to conduct wireless communication to the interrogator;
a means for suspending the imparting of the right to conduct wireless communication to the interrogator;
a means for making suspension information; and
a means for performing cancellation of registration of the interrogator.

7. An identification system comprising:
an interrogator which conducts wireless communication with a wireless tag and a management server which manages the interrogator,
wherein the interrogator includes:
a means for performing registration application to the management server;
a means for performing carrier sense;
a means for transmitting a result of the carrier sense to the management server;
a means for applying to the management server for a right to conduct wireless communication;
a means for starting wireless communication by obtaining the right to conduct wireless communication;
a means for returning the right to conduct wireless communication to the management server when wireless communication with the wireless tag is ended; and
a means for applying to the management server for cancellation of registration,
wherein the management server includes a recording medium, and
wherein the recording medium records a program by which the management server functions as;
a means for performing a registration of the interrogator,
a means for making an interrogator information,
a means for making the interrogator transmit and stop a wireless signal,
a means for making the interrogator start and stop carrier sense,
a means for making the interrogator transmit a result of carrier sense,
a means for making interrogator interference information,
a means for imparting the right to conduct wireless communication to the interrogator,
a means for suspending the imparting of the right to conduct wireless communication to the interrogator,
a means for making suspension information, and
a means for performing cancellation of registration of the interrogator.

8. An identification method according to claim 1 further comprising:
applying to the management server for cancellation of registration, and
deregistering the interrogator.

9. An identification method according to claim 1 further comprising:
applying to the management server for a right to conduct wireless communication,
imparting the right to conduct wireless communication to the interrogator,
conducting wireless communication with the wireless tag, and
returning the right to conduct wireless communication to the management server.

10. An identification method according to claim 1 further comprising:
suspending imparting of the right to conduct wireless communication to the interrogator, and
making a suspension information.

11. An identification method according to claim 8 further comprising:
suspending imparting of the right to conduct wireless communication to the interrogator, and
making a suspension information.

12. An identification method according to claim 9 further comprising:
suspending imparting of the right to conduct wireless communication to the interrogator, and
making a suspension information.
